(19) United States
(12) Patent Application Publication
(10) Pub. No.: US 2020/0160335 A1
(43) Pub. Date: May 21, 2020

(54) VEHICLE PAYMENT SUPPORT DEVICE

(71) Applicant: HONDA MOTOR CO., LTD., Minato-ku, Tokyo (JP)

(72) Inventors: Yuji Yasui, Wako-shi (JP); Kentaro Ishisaka, Wako-shi (JP); Nobuyuki Watanabe, Wako-shi (JP); Kovi Ahego, Wako-shi (JP); Christopher Lang, Wako-shi (JP); Liyan Liu, Tokyo (JP); Yo Ito, Tokyo (JP); Hirotaka Uchitomi, Tokyo (JP)

(21) Appl. No.: 16/620,912

(22) PCT Filed: Jun. 12, 2018
(86) PCT No.: PCT/JP2018/022332

§ 371 Date: Dec. 10, 2019

(30) Foreign Application Priority Data
Jun. 16, 2017 (JP) 2017-118920

(51) Int. Cl. G06Q 20/40; G06Q 20/34

(52) U.S. Cl. CPC G06Q 20/401; G06Q 20/34

(57) ABSTRACT

A vehicle payment support device includes: an acquirer configured to acquire payment information of a fee which is able to be associated with identification information of a vehicle providing a service from a fee collection system; and an associator configured to associate the service from the vehicle and the payment information with identification information of the vehicle and determine a charged amount based on association of a price of the service by the vehicle and a price of a service or a product of which payment is confirmed by the fee collection system with the identification information of the vehicle.

### TECHNICAL FIELD

The present invention relates to a vehicle payment support device. Priority is claimed on Japanese Patent Application No. 2017-118920, filed Jun. 16, 2017, the content of which is incorporated herein by reference.

### BACKGROUND ART

In the related art, a system in which fees at the time of passing through toll ways are automatically collected using an electronic toll collection system (hereinafter referred to as an ETC system) is known (for example, see Patent Literature 1). In the ETC systems, on-road devices and in-vehicle devices communicate with each other and fees are automatically collected based on information regarding cards inserted into the in-vehicle devices (hereinafter referred to as ETC cards).

In addition, in the related art, an electronic money system in which contactless integrated circuit (IC) cards using a radio frequency identifier (RFID) technology and contactless IC card readers perform collecting fees using electronic money is known (for example, see Patent Literature 2). In this electronic money system, a communication terminal or the like on which a contactless IC card or a contactless IP chip using an RFID technology is mounted and a contactless IC card reader communicate with each other and collecting fees is performed with electronic money.

### CITATION LIST

### Patent Literature

[Patent Literature 1]

Japanese Unexamined Patent Application, First Publication No. 2000-99784
[Patent Literature 2]

Japanese Unexamined Patent Application, First Publication No. 2002-366862

### SUMMARY OF INVENTION

### Technical Problem

Here, an ETC card, a contactless IC card of an electronic money system, or the like is generally a post-paid (credit) type of card. A user can obtain such a card when the user makes an application to a service provider that supplies each service.

However, before the user obtains such a card, a time for registration, delivery, and the like is necessary in some cases. In addition, it is difficult for foreigners or the like visiting for touring to make an application for the service in some cases.

The present invention is devised in view of the foregoing problems and an object of the present invention is to provide a vehicle payment support device capable of supporting a user of a vehicle to pay various fees simply.

### Solution to Problem

A vehicle control system, a vehicle control method, and a program according to the present invention adopt the following configurations.

(1) According to an aspect of the present invention, a vehicle payment support device includes: an acquirer configured to acquire payment information of a fee which is able to be associated with identification information of a vehicle providing a service from a fee collection system; and an associator configured to associate the service from the vehicle and the payment information with identification information of the vehicle and associate a price of the service by the vehicle and a price of a service or a product of which payment is confirmed by the fee collection system with the identification information of the vehicle.

(2) In the vehicle payment support device according to the aspect (1), the fee collection system may confirm the payment by authenticating a card medium. The payment information of the fee associable with the identification information of the vehicle may include card identification information stored in the card medium. The associator may associate the payment information with the identification information of the vehicle with reference to association information of the identification information of the vehicle and the card identification information, and associate the price of the service by the vehicle and the price of the service or the product of which the payment is confirmed by the fee collection system with the identification information of the vehicle.

(3) In the vehicle payment support device according to the aspect (1) or (2), the fee collection system may confirm the payment by authenticating a key used for locking and unlocking of the vehicle. The payment information of the fee associable with the identification information of the vehicle may include key identification information stored in the key. The associator may associate the payment information with the identification information of the vehicle with reference to association information of the identification information of the vehicle and the key identification information, and associate the price of the service by the vehicle and the price of the service or the product of which the payment is confirmed by the fee collection system with the identification information of the vehicle.

(4) In the vehicle payment support device according to any one of the aspects (1) to (3), the fee collection system may confirm the payment by authenticating a communication terminal associated with the vehicle. The payment information of the fee associable with the identification information of the vehicle may include communication terminal identification information stored in the communication terminal. The associator may associate the payment information with the identification information of the vehicle with reference to association information of the identification information of the vehicle and the communication terminal identification information, and associate the price of the service by the vehicle and the price of the service or the product of which the payment is confirmed by the fee collection system with the identification information of the vehicle.

(5) In the vehicle payment support device according to any one of the aspects (1) to (4), the fee collection system may confirm the payment by authenticating a communication terminal associated for each compartment or seat of the vehicle. The payment information of the fee associable with the identification information of the vehicle may include communication terminal identification information stored in the communication terminal. The associator may associate the payment information with the identification information of the vehicle with reference to association information of the identification information of the vehicle and the communication terminal identification information, and associate the price of the service by the vehicle and the price of the service or the product of which the payment is confirmed by the fee collection system with the identification information of the vehicle.

(6) In the vehicle payment support device according to any one of the aspects (1) to (5), the associator may associate the payment information with the identification information of the vehicle based on a period in which a user uses the vehicle and associate the price of the service by the vehicle and the price of the service or the product of which the payment is confirmed by the fee collection system with the identification information of the vehicle.

(7) According to another aspect of the invention, a vehicle payment support device includes: an acquirer configured to acquire payment information of a fee; a transmitter configured to associate a service by a vehicle with the payment information of the fee, and associate identification information of the vehicle and the payment information of the fee and transmit the identification information of the vehicle and the payment information of the fee to a fee collection system in accordance with the transmission to the fee collection system; and an associator configured to associate the service from the vehicle and the payment information with the identification information of the vehicle when the transmitter transmits the identification information of the vehicle, and associate a price of the service by the vehicle and a price of a service or a product of which payment is confirmed by the fee collection system with the identification information of the vehicle.

### Advantageous Effects of Invention

According to the above-described aspects (1) to (5), various fees can be paid based on information regarding a vehicle.

### BRIEF DESCRIPTION OF DRAWINGS

FIG. 1 is a diagram (part 1) illustrating an overview of a vehicle payment system according to an embodiment.

FIG. 2 is a diagram (part 2) illustrating an overview of a vehicle payment system according to an embodiment.

FIG. 3 is a diagram (part 1) illustrating a functional configuration of the vehicle payment system according to the embodiment.

FIG. 4 is a diagram illustrating an example of usage fee information of an ETC system according to the embodiment.

FIG. 5 is a diagram illustrating an example of usage fee information of an electronic money system according to the embodiment.

FIG. 6 is a diagram (part 2) illustrating a functional configuration of the vehicle payment system according to the embodiment.

FIG. 7 is a diagram illustrating an example of charging information of the ETC system according to the embodiment.

FIG. 8 is a diagram illustrating an example of registration information of the ETC system according to the embodiment.

FIG. 9 is a diagram illustrating an example of charging information of the electronic money system according to the embodiment.

FIG. 10 is a diagram illustrating an example of registration information of the electronic money system according to the embodiment.

FIG. 11 is a diagram illustrating an example of payment information of the ETC system according to the embodiment.

FIG. 12 is a diagram illustrating an example of payment information of the electronic money system according to the embodiment.

FIG. 13 is a diagram illustrating an example of registration information according to the embodiment.

FIG. 14 is a diagram (part 1) illustrating an example of usage information according to the embodiment.

FIG. 15 is a diagram (part 2) illustrating an example of the usage information according to the embodiment.

FIG. 16 is a flowchart illustrating an example of an operation of the vehicle payment system according to the embodiment.

### DESCRIPTION OF EMBODIMENTS

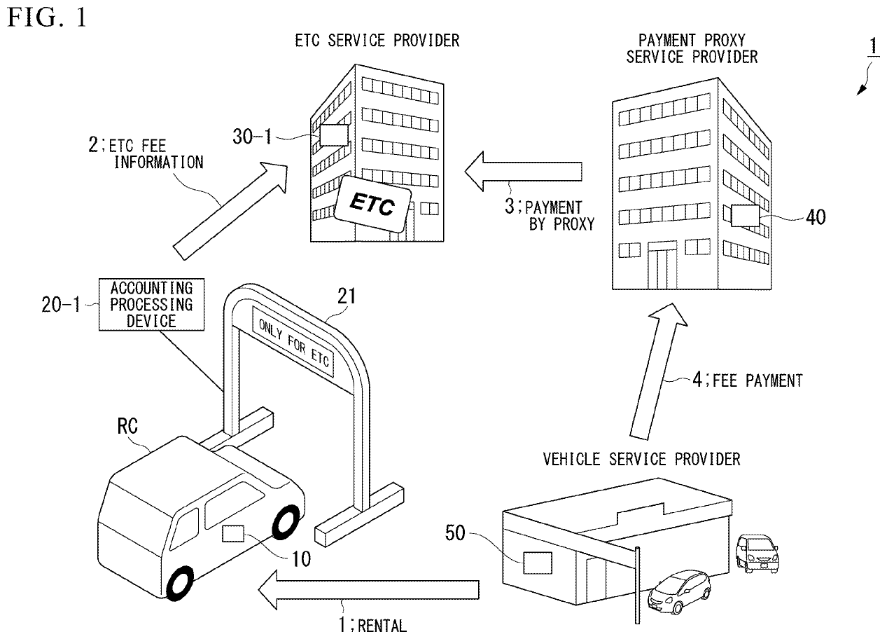

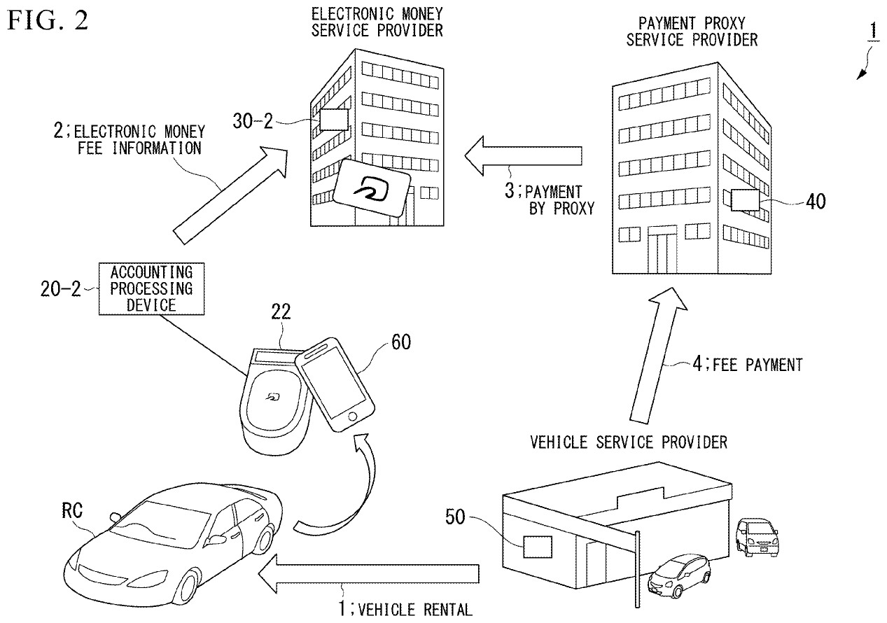

Hereinafter, a vehicle payment system 1 according to an embodiment will be described with reference to FIGS. 1 and 2. FIG. 1 is a diagram (part 1) illustrating an overview of the vehicle payment system 1 according to the embodiment. FIG. 2 is a diagram (part 2) illustrating an overview of the vehicle payment system 1 according to the embodiment. The vehicle payment system 1 is, for example, a system that provides a structure in which a user who rents and uses a vehicle (hereinafter referred to as a rental car RC on the premise of a rental car service) from a service provider providing a vehicle service such as a rental car service or a ridesharing service (hereinafter referred to as a vehicle service provider) pays a usage fee of the rental car RC and other fees together to a vehicle service provider. FIG. 1 illustrates an overview of the vehicle payment system 1 when fees collected by a fee collection system are a toll road usage fee incurred using the rental car RC on a toll road and collected by an electronic toll collection system (hereinafter referred to as an ETC system). A case in which the fees collected by the fee collection system are fees of electronic money used by the user of the rental car RC while the user rents the rental car RC in FIG. 2 will be described.

### [ETC System]

First, the user rents the rental car RC from a vehicle service provider that is an owner of the rental car RC. An ETC in-vehicle device 10 is mounted on the rental car RC. A card used when the ETC system is used (hereinafter referred to as an ETC card) is inserted into the ETC in-vehicle device 10. The rental car RC in which the ETC card is inserted into the ETC in-vehicle device 10 can use an automated collection service for a usage fee of a toll road incurred using the ETC system.

Here, the ETC card inserted into the ETC in-vehicle device 10 mounted on the rental car RC is, for example, a post-paid (credit) type of card. The ETC card is a card that is registered in a business provider administrating the ETC system (hereinafter referred to as an ETC service provider) in the name of the vehicle service provider. One ETC in-vehicle device 10 is mounted on the vehicle (the rental car RC) and one ETC card is inserted into the ETC in-vehicle device 10. In the following description, the ETC card inserted into the ETC in-vehicle device 10 of the rental car RC is also referred to as an ETC card mounted on the rental car RC. The usage fee of the toll road used with the ETC card is a fee associated with a usage fee of the rental card RC by the vehicle payment system 1.

An accounting processing device 20-1 is a device that calculates fees which are usage fees incurred during using a vehicle (in this example, the rental car RC) and are fees collected by a fee collection system. The accounting processing device 20-1 calculates fees that are fees incurred when the rental car RC travels on a toll road and are toll road usage fees collected by the ETC system. A detection device 21 is connected to the accounting processing device 20-1. For example, the accounting processing device 20-1 and the detection device 21 are installed at each tollgate of a toll road. The ETC in-vehicle device 10 and the detection device 21 transmit and receive information through wireless communication near the detection device 21. The wireless communication is, for example, a dedicated short range communications. The detection device 21 travels near the detection device 21. That is, information indicating a tollgate (hereinafter referred to as tollgate information) is transmitted to the rental car RC passing through the tollgate. The ETC in-vehicle device 10 receives the tollgate information from the detection device 21. The tollgate information is stored in the ETC card by the ETC in-vehicle device 10. The ETC in-vehicle device 10 updates the tollgate information stored in the ETC card whenever the rental car RC passes through the tollgate, that is, the tollgate information is received from the detection device 21.

The detection device 21 detects information that is information regarding a vehicle passing through the tollgate (in this example, the rental car RC) and is information used when a toll road usage fee of the vehicle is calculated (hereinafter referred to as vehicle information). The vehicle information is, for example, information indicating a vehicle height, a vehicle length, the number of vehicle wheels. The detection device 21 receives information for identifying the ETC card (hereinafter referred to as an ETC card ID) from the ETC in-vehicle device 10.

The accounting processing device 20-1 calculates a fee related to traveling of the rental car RC on a toll road to an installation position of the detection device 21 based on the vehicle information detected by the detection device 21 and the tollgate information received from the ETC in-vehicle device 10. Specifically, the accounting processing device 20-1 determines a model of the rental car RC based on the vehicle information. The accounting processing device 20-1 calculates a usage fee of the toll road in the traveling of the determined model of the vehicle from a tollgate indicated by the tollgate information to a tollgate at which the accounting processing device 20-1 is installed. The accounting processing device 20-1 transmits information indicating the usage fee of the toll road to an ETC server 30-1.

### [ETC Service Provider]

The ETC server 30-1 is a device that requests a vehicle to perform payment of a fee charged for the vehicle by proxy. In the example of the embodiment, the ETC server 30-1 is a device owned by the ETC service provider. The ETC service provider charges a vehicle using a toll road using the ETC system. The ETC service provider requests a business provider performing a payment proxy service by proxy for a user of a toll road (hereinafter referred to as a payment proxy service provider) to perform payment of the usage fee of the toll road by proxy. The ETC server 30-1 calculates an amount of money by which the payment proxy service provider is requested to perform the payment by proxy based on the fee information.

### [Electronic Money System]

Hereinafter, the vehicle payment system 1 according to the embodiment will be described with reference to the drawing. FIG. 2 is a diagram (part 2) illustrating an overview of the vehicle payment system 1 according to an embodiment. In the embodiment, the user of the rental car RC rents a terminal capable of using electronic money as well when the user rents the rental car RC from the vehicle service provider. The terminal capable of using electronic money is, for example, a communication terminal performing wireless communication via a mobile communication network or the like (hereinafter referred to as a communication terminal 60). Specifically, the communication terminal 60 is, for example, a portable personal computer such as a mobile phone, a smartphone, and a tablet computer (a tablet PC). The communication terminal 60 can use an automated collection service for a usage fee realized using the electronic money system.

Here, a contactless IC chip is mounted on the communication terminal 60. The contactless IC chip is, for example, a post-paid (credit) type of chip. The contactless IC chip is registered in a service provider that administrates the electronic money system in the name of the vehicle service provider (hereinafter referred to as an electronic money service provider). One contactless IC chip is mounted on the communication terminal 60. A usage fee of the electronic money system used by the communication terminal 60 is a fee associated with a usage fee of the rental car RC by the vehicle payment system 1.

An accounting processing device 20-2 calculates a fee paid by electronic money (hereinafter referred to as a usage fee in electronic money) using the communication terminal 60. A detection device 22 is connected to the accounting processing device 20-2. The accounting processing device 20-2 is, for example, a device that calculates a fee such as a register. The accounting processing device 20-2 acquires information (hereinafter referred to as value information) regarding fees of services or products from an input unit (not illustrated) such as a barcode reader or a numeric key and calculates a total amount of the fees indicated by the value information. The detection device 22 is, for example, an IC card reader/writer. The accounting processing device 20-2 and the detection device 22 are installed in, for example, a retail store, a vending machine, and a place at which a transportation expense of a public transportation system is incurred. The communication terminal 60 and the detection device 22 transmit and receive information through wireless communication near the detection device 22. The wireless communication is, for example, a near field communication. The detection device 22 transmits value information calculated by the accounting processing device 20 to the communication terminal 60 (for example, the communication terminal 60 held over the detection device 22) coming close to the detection device 22. The communication terminal 60 receives the value information from the detection device 22. The value information is stored in the contactless IC chip by the communication terminal 60. The detection device 22 receives information for identifying the contactless IC ship mounted on the communication terminal 60 (hereinafter referred to as a contactless IC chip ID) from the communication terminal 60.

The accounting processing device 20-2 calculates a usage fee in electronic money based on the value information input by the input unit. Specifically, the accounting processing device 20-2 calculates a total sum of the value information as a usage fee of the electronic money. The accounting processing device 20-2 transmits information indicating the usage fee of the electronic money to an electronic money server 30-2.

### [Electronic Money Service Provider]

The electronic money server 30-2 is a device owned by the electronic money service provider. The electronic money service provider charges the communication terminal 60 using the electronic money system. The electronic money service provider requests a payment proxy service provider to perform payment of usage fees in electronic money by proxy in place of a user of electronic money. The electronic money server 30-2 calculates a charged amount for which the payment proxy service provider is requested to perform payment by proxy based on usage fee information 290-2.

### [Payment Proxy Service Provider]

A payment proxy processing device 40 is a device owned by the payment proxy service provider. The payment proxy service provider acts as a proxy for payment of an amount of money calculated by the ETC server 30-1. Specifically, the payment proxy service provider pays the amount of money calculated by the ETC server 30-1 to the ETC service provider. The payment proxy processing device 40 calculates a usage fee for the user of the ETC system based on a usage history of the ETC system. As described above, in this example, the user of the rental car RC uses the ETC system by using the ETC card registered in the name of the vehicle service provider. Accordingly, the payment proxy processing device 40 calculates a usage fee to be charged to the vehicle service provider.

The payment proxy service provider acts as a proxy for payment of an amount of money calculated by the electronic money server 30-2. Specifically, the payment proxy service provider pays the amount of money calculated by the electronic money server 30-2 to the electronic money service provider. The payment proxy processing device 40 calculates a usage fee for the user of the electronic money system based on the usage history of an electronic money system. As described above, in this example, the user of the rental car RC uses the electronic money system using the communication terminal 60 (the contactless IC chip) registered in the name of the vehicle service provider. Accordingly, the payment proxy processing device 40 calculates the usage fee charged to the vehicle service provider.

### [Vehicle Service Provider]

A vehicle payment support device 50 is a device owned by the vehicle service provider. The vehicle service provider pays a usage fee calculated by the payment proxy processing device 40 to the payment proxy service provider. The vehicle payment support device 50 calculates a charged fee to be charged to the user based on the usage fee of the rental car RC used by the user and fees collected by the fee collection system during using the rental car RC. The vehicle payment support device 50 calculates a charged fee to be charged to the user of the ETC system based on a usage history of the ETC system. The vehicle payment support device 50 calculates a charged fee to be charged to the user of the electronic money system based on the usage history of the electronic money system. The vehicle service provider charges the user a charged fee which is the charged fee calculated by the vehicle payment support device 50 and is a charged fee associated with use of the ETC system and the electronic money system.

### [Configuration of Vehicle Payment System]

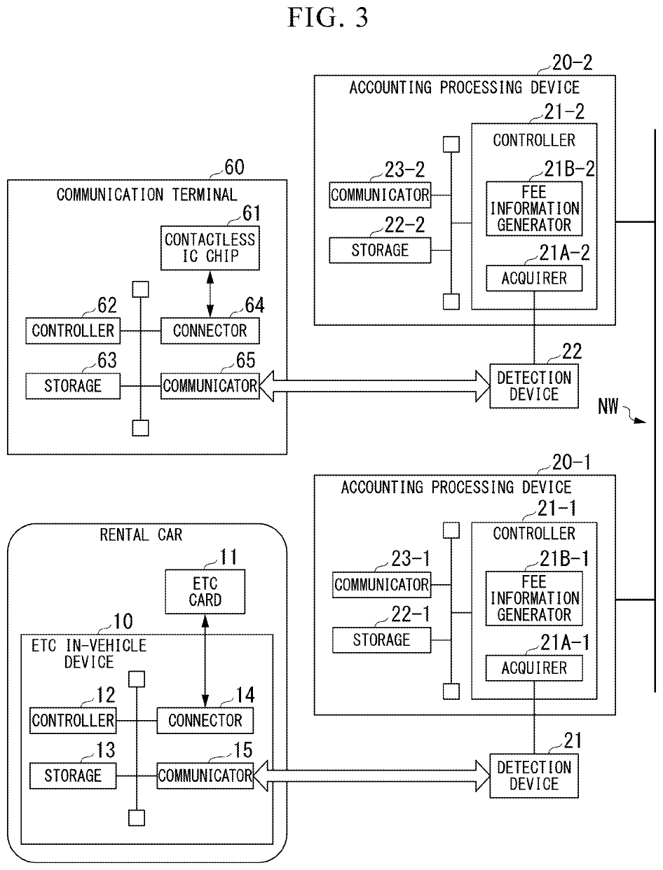

Hereinafter, a specific configuration of the vehicle payment system 1 will be described with reference to the drawing. FIG. 3 is a diagram (part 1) illustrating a functional configuration of the vehicle payment system 1 according to the embodiment. Specifically, FIG. 3 is a diagram illustrating a functional configuration of the accounting processing devices 20-1 and 20-2 included in the vehicle payment system 1. The accounting processing devices 20-1 and 20-2 are connected to each other via a network NW.

### [ETC In-Vehicle Device]

As described above, the ETC in-vehicle device 10 is mounted on the rental car RC. An ETC card 11 is inserted into the ETC in-vehicle device 10. The ETC in-vehicle device 10 includes, for example, a controller 12, a storage 13, a connector 14, and a communicator 15. The controller 12 controls an operation of each unit included in the ETC in-vehicle device 10. A process of the controller 12 is realized, for example, by causing a processor such as a central processing unit (CPU) to execute a program stored in the storage 13. The functional units may be realized by hardware such as a large scale integration (LSI), an application specific integrated circuit (ASIC), or a field-programmable gate array (FPGA) or may be realized by software and hardware in cooperation. The connector 14 stores tollgate information in the ETC card 11 under the control of the controller 12. The connector 14 reads the tollgate information from the ETC card 11 under the control of the controller 12. The communicator 15 transmits or receives the tollgate information to and from a detection device 21 through wireless communication. Here, the tollgate information received by the communicator 15 is tollgate information written on the ETC card 11. The tollgate information received by the communicator 15 is tollgate information written on the ETC card 11. The communicator 15 transmits the ETC card ID to the detection device 21.

### [Accounting Processing Device and Detection Device: ETC System]

The accounting processing device 20-1 and the detection device 21 are connected to each other. The detection device 21 outputs the tollgate information and the ETC card ID received from the ETC in-vehicle device 10 to the accounting processing device 20-1. The detection device 21 outputs detected vehicle information to the accounting processing device 20-1.

The accounting processing device 20-1 includes, for example, a controller 21-1, a storage 22-1, and a communicator 23-2. The controller 21-1 executes a program stored in the storage 22-1 to realize an acquirer 21A-1 and a fee information generator 21B-1 as functional units. The tollgate information, the ETC card ID, and the vehicle information are input from the detection device 21 to the acquirer 21A-1. The fee information generator 21B-1 calculates a usage fee of a toll road based on the tollgate information and the vehicle information input to the acquirer 21A-1. Specifically, the fee information generator 21B-1 calculates a usage fee when a model of a vehicle indicated by the vehicle information uses a toll road from a tollgate indicated by the tollgate information to a tollgate in which the accounting processing device 20-1 is installed. The communicator 23-2 transmits usage fee information in which information indicating the usage fee of the toll road calculated by the fee information generator 21B-1, information indicating a usage place, and an ETC card ID are associated with each other (hereinafter referred to as usage fee information 290) to the ETC server 30-1 via the network NW. The information indicating the usage place is information indicating a section from the tollgate indicated by the tollgate information to the tollgate in which the accounting processing device 20-1 is installed.

### [Usage Fee Information]

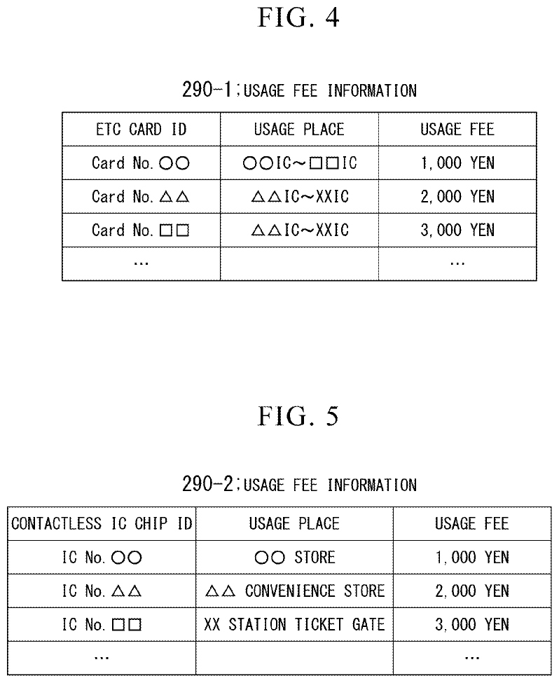

Hereinafter, the details of the usage fee information 290-1 will be described with reference to the drawing. FIG. 4 is a diagram illustrating an example of usage fee information 290-1 of an ETC system according to the embodiment. The ETC card ID, the information indicating the usage place, and the information indicating the usage fee of the toll road are associated with the usage fee information 290-1. The accounting processing device 20-1 generates usage fee information 290-1 for each vehicle passing through the tollgate in which the accounting processing device 20-1 is installed.

### [Communication Terminal]

Referring back to FIG. 3, a contactless IC chip 61 is mounted on the communication terminal 60. The communication terminal 60 includes, for example, a controller 62, a storage 63, a connector 64, and a communicator 65. The controller 62 controls an operation of each unit included in the communication terminal 60 by executing a program stored in the storage 63. The communicator 65 transmits and receives information to and from the detection device 22 through wireless communication. For example, the communicator 65 receives electronic money fee information from the detection device 22 and outputs the electronic money fee information to the controller 62. The connector 64 writes the electronic money fee information received by the communicator 65 on the contactless IC chip 61. The connector 64 reads a contactless IC chip ID from the contactless IC chip 61 and outputs the contactless IC chip ID to the communicator 65. The communicator 65 transmits the contactless IC chip ID stored in the contactless IC chip 61 to the detection device 22.

### [Accounting Processing Device and Detection Device: Electronic Money System]

The accounting processing device 20-2 and the detection device 22 are connected to each other. The detection device 22 outputs a contactless IC chip ID from the communication terminal 60 to the accounting processing device 20-2. The input unit inputs value information to the accounting processing device 20-2.

The accounting processing device 20-2 has a similar configuration to the accounting processing device 20-1. The contactless IC chip ID and the value information are input from the detection device 22 to the acquirer 21A-2. The fee information generator 21B-2 calculates a usage fee in electronic money based on the value information input to the acquirer 21A-2. Specifically, the fee information generator 21B-2 calculates a total amount of value information as the usage fee in electronic money. The communicator 65 transmits usage fee information in which information indicating the usage fee in electronic money calculated by the fee information generator 21B-2, information indicating a usage place, and the contactless IC chip ID are associated with each other (hereinafter referred to as usage fee information 290-2) to the electronic money server 30-2 via the network NW. The information indicating the usage place is information indicating an installation position of the accounting processing device 20-2 or the detection device 22.

### [Usage Fee Information]

Hereinafter, the details of the usage fee information 290-2 will be described with reference to the drawing. FIG. 5 is a diagram illustrating an example of the usage fee information 290-2 of an electronic money system according to the embodiment. A contactless IC chip ID, information indicating a usage place, and information indicating a usage fee in electronic money are associated with the usage fee information 290-1. The accounting processing device 20-2 generates usage fee information 290-2 for each communication terminal 60 used for electronic money at an installation position of the accounting processing device 20-2.

### [ETC Server and ETC Service Database]

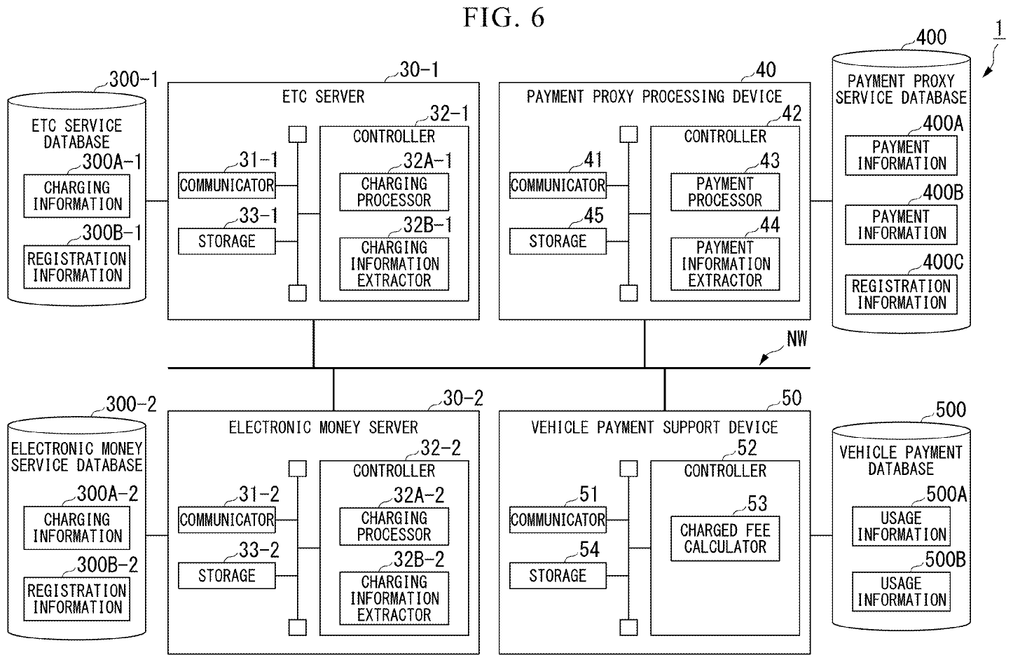

FIG. 6 is a diagram (part 2) illustrating a functional configuration of the vehicle payment system 1 according to the embodiment. Specifically, FIG. 6 is a diagram illustrating a functional configuration of the ETC server 30-1, the electronic money server 30-2, the payment proxy processing device 40, the vehicle payment support device 50, an ETC service database 300-1, an electronic money service database 300-2, a payment proxy service database 400, and a vehicle payment database 500 included in the vehicle payment system 1. The accounting processing device 20-1, the accounting processing device 20-2, the ETC server 30-1, the electronic money server 30-2, the payment proxy processing device 40, and the vehicle payment support device 50 described above are connected to each other via the network NW.

The ETC server 30-1 is connected to the ETC service database 300-1, and reads and writes information from and on the ETC service database 300-1. The ETC server 30-1 includes, for example, a communicator 31-1, a controller 32-1, and a storage 33-1. The communicator 31-1 transmits and receives information via the network NW. For example, the communicator 31-1 receives the usage fee information 290-1 from each accounting processing device 20-1 installed at each tollgate of a toll road. The controller 32-1 executes a program stored in the storage 33-1 to realize a charging processor 32A-1 and a charging information extractor 32B-1 as functional units.

The charging processor 32A-1 charges a vehicle for use of a toll road based on the usage fee information 290-1. As described above, the vehicle (the rental car RC) includes one ETC card 11. Accordingly, a plurality of vehicles on which the ETC card 11 with a certain ETC card ID is mounted do not exist at the same time. That is, it is possible to uniquely determine the vehicle on which the ETC card 11 with the ETC card ID indicated by the usage fee information 290-1 is mounted. The charging processor 32A-1 charges a usage fee included in the usage fee information 290-1 to the vehicle indicated by the ETC card ID of the usage fee information 290-1. Specifically, the charging processor 32A-1 stores information indicating the usage fee for each ETC card ID (hereinafter referred to as charging information 300A-1) in the ETC service database 300-1 based on the usage fee information 290-1.

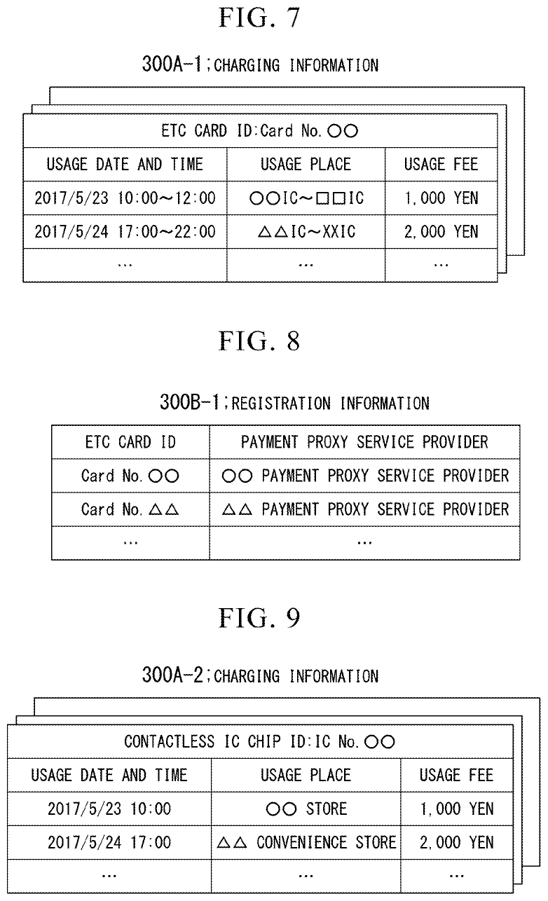

Hereinafter, the details of the charging information 300A-1 will be described with reference to the drawing. FIG. 7 is a diagram illustrating an example of the charging information 300A-1 of the ETC system according to the embodiment. As illustrated in FIG. 7, the charging information 300A-1 is information representing information indicating a usage date and time at which a vehicle uses a toll road, information indicating a usage place included in the usage fee information 290-1, and information indicating the usage fee for each ETC card ID. The information indicating a usage data and time is, for example, information indicating a date and time from a date and time at which the usage fee information 290-1 including a certain ETC card ID is transmitted from the accounting processing device 20-1 at an entrance of a tollgate to a date and time transmitted from the accounting processing device 20-1 at an exit of a tollgate. The charging processor 32A-1 searches for the charging information 300A-1 using the ETC card ID included in the usage fee information 290-1 as a search key. The charging processor 32A-1 adds a usage fee included in the usage fee information 290-1 to the searched charging information 300A-1. Thus, the charging processor 32A-1 charges the usage fee of a toll road for each vehicle (ETC card ID) based on the usage fee information 290-1.

Referring back to FIG. 6, the charging information extractor 32B-1 extracts the charging information 300A-1 stored in the ETC service database 300-1 for each payment proxy service provider. Here, the ETC card 11 is issued from a plurality of payment proxy service providers in some cases. The payment proxy service provider that has issued the ETC card 11 pays the usage fee charged to the ETC card 11 (the ETC card ID) by proxy. Accordingly, the charging information extractor 32B-1 extracts the usage fee paid by proxy by the payment proxy service provider for each payment proxy service provider based on correspondence between the ETC card ID and the payment proxy service provider.

Hereinafter, the details of the registration information 300B-1 will be described with reference to the drawing. FIG. 8 is a diagram illustrating an example of the registration information 300B-1 of the ETC system according to the embodiment. The registration information 300B-1 is information indicating the ETC card ID of the ETC card 11 capable of using the ETC system and the name of the payment proxy service provider associated with the ETC card ID. For example, the charging information extractor 32B-1 searches for the registration information 300B-1 using the name of a certain payment proxy service provider as a search key.

The charging information extractor 32B-1 acquires the ETC card ID corresponding to the searched payment proxy service provider. The charging information extractor 32B-1 extracts the charging information 300A-1 corresponding to the acquired ETC card ID among the pieces of charging information 300A-1. The communicator 31-1 transmits the extracted charging information 300A-1 to the payment proxy processing device 40 owned by the payment proxy service provider used as the search key. The charging information extractor 32B-1 extracts the charging information 300A-1 for each payment proxy service provider. The communicator 31-1 transmits the charging information 300A-1 extracted for each payment proxy service provider by the charging information extractor 32B-1 to each payment proxy processing device 40 owned by each payment proxy service provider.

### [Electronic Money Server and Electronic Money Service Database]

The electronic money server 30-2 is connected to the electronic money service database 300-2, and reads and writes information from and on the electronic money service database 300-2. The electronic money server 30-2 has a similar configuration to the ETC server 30-1.

The charging processor 32A-2 charges a vehicle using electronic money based on the usage fee information 290-2. As described above, the charging processor 32A-2 stores information indicating a usage fee for each contactless IC chip ID (hereinafter referred to as charging information 300A-2) in the electronic money service database 300-2 based on the usage fee information 290-2.

Hereinafter, the details of the charging information 300A-2 will be described with reference to the drawing. FIG. 9 is a diagram illustrating an example of the charging information 300A-2 of the electronic money system according to the embodiment. As illustrated in FIG. 9, the charging information 300A-2 is information representing information indicating a usage date and time at which a vehicle uses electronic money, information indicating a usage place included in the usage fee information 290-2, and information indicating a usage fee for each contactless IC chip ID. The information indicating the usage date and time is, for example, information indicating a date and time at which the usage fee information 290-2 including a certain contactless IC chip ID is transmitted from the accounting processing device 20-2. The charging processor 32A-2 searches for the charging information 300A-2 using the contactless IC chip ID included in the usage fee information 290-2 as a search key. The charging processor 32A-2 adds the usage fee included in the usage fee information 290-2 to the searched charging information 300A-2. Thus, the charging processor 32A-2 charges the usage fee in electronic money for each contactless IC chip ID based on the usage fee information 290-2.

Referring back to FIG. 6, a charging information extractor 32B-2 extracts the charging information 300A-2 stored in the electronic money service database 300-2 for each payment proxy service provider. Here, the payment proxy service provider set at the time of use registration of the electronic money service pays the usage fee charged to the contactless IC chip ID by proxy. Accordingly, the charging information extractor 32B-2 extracts the usage fee paid by proxy by the payment proxy service provider for each payment proxy service provider based on correspondence between the contactless IC chip ID and the payment proxy service provider.

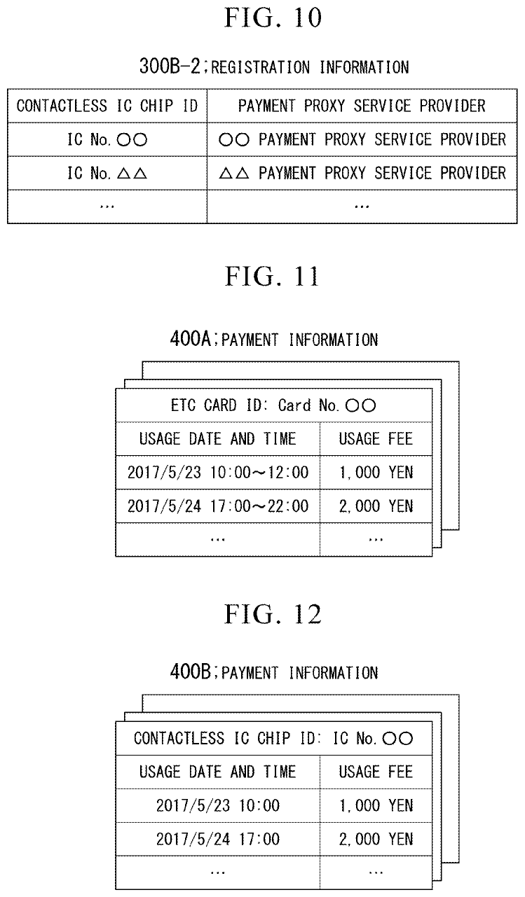

Hereinafter, the details of registration information 300B-2 will be described with reference to the drawing. FIG. 10 is a diagram illustrating an example of the registration information 300B-2 of the electronic money system according to the embodiment. The registration information 300B-2 is information indicating a contactless IC chip ID of the communication terminal 60 capable of using the ETC system and the name of a payment proxy service provider associated with the contactless IC chip ID. For example, the charging information extractor 32B-2 searches for the registration information 300B-2 using the name of a certain payment proxy service provider as a search key.

The charging information extractor 32B-2 acquires the contactless IC chip ID corresponding to the searched payment proxy service provider. The charging information extractor 32B-2 extracts the charging information 300A-2 corresponding to the acquired contactless IC chip ID among the pieces of charging information 300A-2. The communicator 31-2 transmits the extracted charging information 300A-2 to the payment proxy processing device 40 owned by the payment proxy service provider used as the search key. The charging information extractor 32B-2 extracts the charging information 300A-2 for each payment proxy service provider. The communicator 31-2 transmits the charging information 300A-2 extracted for each payment proxy service provider by the charging information extractor 32B-2 to each payment proxy processing device 40 owned by each payment proxy service provider.

### [Payment Proxy Processing Device and Payment Proxy Service Database]

The payment proxy processing device 40 is connected to the payment proxy service database 400, and reads and writes information from and on the payment proxy service database 400. The payment proxy processing device 40 includes, for example, a communicator 41, a controller 42, and a storage 45. The communicator 41 transmits and receives information via the network NW. For example, the communicator 41 receives the charging information 300A-1 from the ETC server 30-1 and receives the charging information 300A-2 from the electronic money server 30-2. The controller 42 executes a program stored in the storage 45 to realize a payment processor 43 and a payment information extractor 44 as functional units.

The payment processor 43 pays the ETC service provider a sum amount of a usage fee of a toll road indicated by the charging information 300A-1 and a usage fee in electronic money indicated by the charging information 300A-2 by proxy based on the charging information 300A-1 and the charging information 300A-2. The payment processor 43 stores information in which an ETC card ID, a usage date and time, and a usage fee with which payment by proxy is performed for the ETC service provider (hereinafter referred to as payment information 400A) are associated in the payment proxy service database 400 based on the charging information 300A-1. The payment processor 43 stores information in which a contactless IC chip ID, a usage date and time, and a usage fee with which payment by proxy is performed for the electronic money service provider are associated (hereinafter referred to as payment information 400B) in the payment proxy service database 400 based on the charging information 300A-2.

Hereinafter, the details of the payment information 400A will be described with reference to the drawing. FIG. 11 is a diagram illustrating an example of the payment information 400A of the ETC system according to the embodiment. As illustrated in FIG. 11, the payment information 400A is information representing information indicating a usage date and time at which a vehicle uses a toll road and information indicating a usage fee for each ETC card ID.

Hereinafter, the details of the payment information 400B will be described with reference to the drawing. FIG. 12 is a diagram illustrating an example of the payment information 400B of the electronic money system according to the embodiment. As illustrated in FIG. 12, the payment information 400B is information representing information indicating a usage date and time at which the communication terminal 60 associated with the vehicle uses electronic money and information indicating a usage fee for each contactless IC chip ID.

Referring back to FIG. 6, the payment information extractor 44 extracts the payment information 400A stored in the payment proxy service database 400 for each registrant of the ETC system. As described above, the ETC card 11 is registered in the ETC service provider in the name of the vehicle service provider. That is, the payment information extractor 44 extracts the payment information 400A for each vehicle service provider among the pieces of payment information 400A.

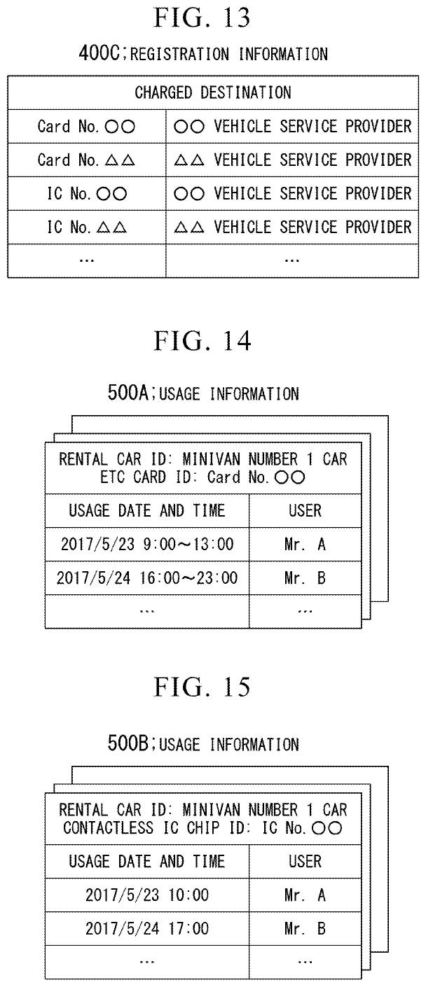

Hereinafter, the details of registration information 400C will be described with reference to the drawing. FIG. 13 is a diagram illustrating an example of the registration information 400C according to the embodiment. The registration information 400C is information representing the name of a registrant associated with the ETC card 11 (the ETC card ID) with which the payment proxy service provider pays a usage fee of a toll road by proxy or the communication terminal 60 (the contactless IC chip ID) paying a usage fee in electronic money by proxy. For example, the payment information extractor 44 searches for the registration information 400C using the name of a certain registrant as a search key. In the example of the embodiment, the payment information extractor 44 searches for the registration information 400C using the name of the vehicle service provider as a search key.

The payment information extractor 44 acquires an ETC card ID corresponding to the searched vehicle service provider. The payment information extractor 44 extracts the payment information 400A corresponding to the acquired ETC card ID among the pieces of payment information 400A. The communicator 41 transmits the extracted payment information 400A to the vehicle payment support device 50 owned by the vehicle service provider used as the search key. The payment information extractor 44 extracts the payment information 400A for each vehicle service provider. The communicator 41 transmits the payment information 400A extracted for each vehicle service provider by the payment information extractor 44 to the vehicle payment support device 50 owned by each vehicle service provider.

The payment information extractor 44 extracts the payment information 400B stored in the payment proxy service database 400 for each registrant of the electronic money service provider as in the configuration of the payment information 400A. The communicator 41 transmits the payment information 400B extracted for each vehicle service provider by the payment information extractor 44 to the vehicle payment support device 50 owned by each vehicle service provider.

### [Vehicle Payment Support Device and Vehicle Payment Database]

Referring back to FIG. 6, the vehicle payment support device 50 is connected to the vehicle payment database 500, and reads and writes information from and on the vehicle payment database 500. The vehicle payment support device 50 includes, for example, a communicator 51, a controller 52, and a storage 54. The communicator 51 transmits and receives information via the network NW. For example, the communicator 51 receives the payment information 400A and the payment information 400B from the payment proxy processing device 40. The controller 52 executes a program stored in the storage 54 to realize a charged fee calculator 53 as a functional unit.

The charged fee calculator 53 associates a usage fee of a toll road paid by the ETC card presented in the payment information 400A with a user using the rental car RC (or information capable of identifying a user (hereinafter referred to as a user ID)). Specifically, the charged fee calculator 53 calculates a charged fee to be charged to the user of the vehicle for which the usage fee indicated by the payment information 400A is charged based on the payment information 400A. Here, the user does not simultaneously get into a plurality of different rental cars RC. That is, the user using the rental car RC at a certain time can be determined uniquely. The charged fee calculator 53 calculates a charged fee related to a usage fee of a toll road for each user based on the payment information 400A and usage information 500A. The usage information 500A is information in which information indicating a user of the rental car RC and information indicating a usage date and time at which the user uses the rental car RC are associated with each other for each ETC card ID. The usage information 500A is stored in the vehicle payment database 500. The vehicle service provider updates the use information 500A, for example, when the user makes a contract or reservation to rent the rental car RC. The charged fee calculator 53 is an example of an “associator.”

Hereinafter, the details of the usage information 500A will be described with reference to the drawing. FIG. 14 is a diagram (part 1) illustrating an example of the usage information 500A according to the embodiment. As described above, in the usage information 500A, the information indicating the user of the rental car RC (for example, the name of the user) and the information indicating the usage date and time at which the user uses the rental car RC are associated with each other for each ETC card ID.

The charged fee calculator 53 extracts the usage information 500A in which the same ETC card ID as the ETC card ID indicated by the payment information 400A is associated among the pieces of usage information 500A. The charged fee calculator 53 searches for a user associated with a usage time including a usage date and time indicated by the payment information 400A among the pieces of extracted usage information 500A. The charged fee calculator 53 calculates a usage fee associated with the usage date and time indicated by the payment information 400A as a charged fee of the searched user. The charged fee calculator 53 calculates a usage fee of the rental car RC as a charged free of the user based on the rental car ID associated with the extracted usage information 500A.

Hereinafter, a specific example related to charged fee calculation of the charged fee calculator 53 will be described. For example, the charged fee calculator 53 extracts the usage information 500A associated with the same ETC card ID as the ETC card ID (for example, “Card No. OO” illustrated in FIG. 11) indicated by the payment information 400A (for example, see FIG. 14). The charged fee calculator 53 searches for a user (for example, “Mr. A” illustrated in FIG. 14) associated with a usage date and time including a usage date and time (for example, “2017/5/23 10:00˜12:00” illustrated in FIG. 11) indicated by the payment information 400A among the extracted usage information 500A. The charged fee calculator 53 calculates a usage fee (for example, “1,000 yen” illustrated in FIG. 11) associated with the usage date and time (for example, “2017/5/23 10:00˜12:00” illustrated in FIG. 11) indicated by the payment information 400A as a charged fee of the searched user (for example, “Mr. A” illustrated in FIG. 14). The charged fee calculator 53 calculates a usage fee of a rental car ID (for example, “minivan No.1 car” illustrated in FIG. 14) associated with the extracted usage information 500A as a charged fee of the searched user (for example, “Mr. A” illustrated in FIG. 14). The searched user (for example, “Mr. A” illustrated in FIG. 14) pays the vehicle service provider the charged fee calculated by the charged fee calculator 53.

The charged fee calculator 53 calculates a charge fee related to a usage fee in electronic money for each user based on the payment information 400B and usage information 500B as in the configuration of the payment information 400A and the usage information 500A. The charged fee calculator 53 calculates a charged fee to be charged to a user of the vehicle for which the usage fee indicated by the payment information 400B is charged based on the payment information 400B. The charged fee calculator 53 calculates a charged fee related to a usage fee in electronic money for each user based on the payment information 400B and the usage information 500B. The usage information 500B is information in which information indicating a user of the rental car RC and information indicating a usage data and time at which the user uses the rental car RC are associated for each contactless IC chip ID. The usage information 500B is stored in the vehicle payment database 500. The vehicle service provider updates the usage information 500B, for example, when the user makes a contract or reservation to rent the rental car RC.

Hereinafter, the details of the usage information 500B will be described with reference to the drawing. FIG. 15 is a diagram (part 2) illustrating an example of the usage information 500B according to the embodiment. As described above, in the usage information 500B, the information (for example, the name of a user) indicating a user of the rental car RC and the information indicating the usage date and time at which the user uses the rental car RC are associated with each other for each contactless IC chip ID.

The charged fee calculator 53 extracts the usage information 500B in which the same contactless IC chip ID as the contactless IC chip ID indicated by the payment information 400B is associated among the pieces of usage information 500B. The charged fee calculator 53 searches for a user associated with a usage time including a usage date and time indicated by the payment information 400B among the pieces of extracted usage information 500B. The charged fee calculator 53 calculates a usage fee associated with the usage date and time indicated by the payment information 400B as a charged fee of the searched user. The charged fee calculator 53 calculates a usage fee of the rental car RC as a charged free of the user based on the rental car ID associated with the extracted usage information 500B.

### [Operation of Vehicle Payment System]

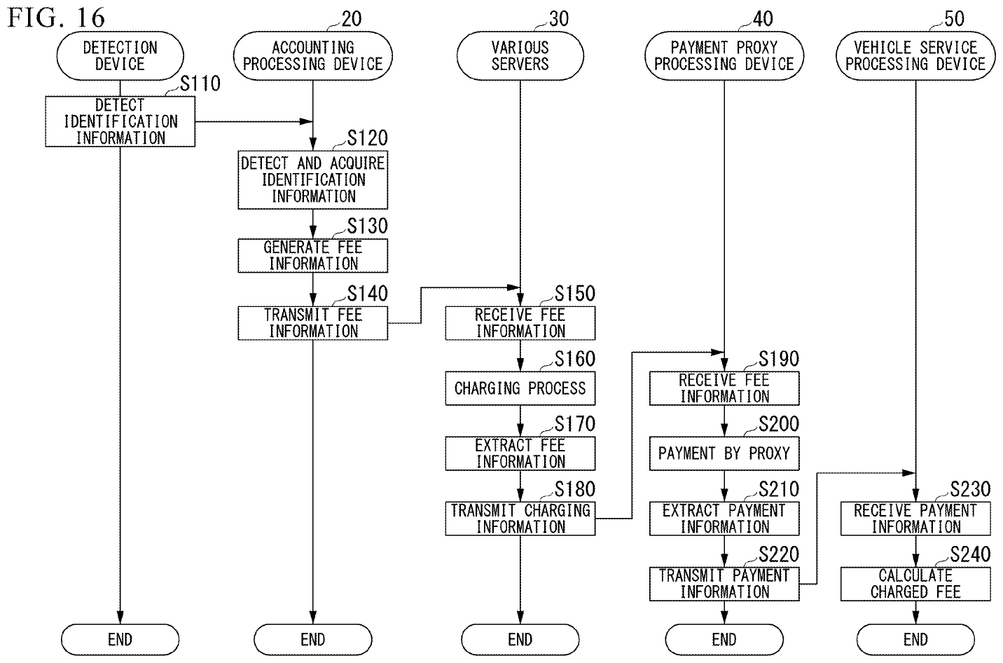

Hereinafter, an operation of the vehicle payment system 1 will be described with reference to the drawing. FIG. 16 is a flowchart illustrating an example of an operation of the vehicle payment system 1 according to the embodiment.

A detection device (the detection device 21 or 22) detects information (the ETC card ID or the contactless IC chip ID) for identifying a vehicle (the rental car RC) passing through a tollgate of a toll road (step S110). The information for identifying the vehicle is input from the detection device to the acquirer 21A (step S120). The fee information generator 21B generates the usage fee information 290 based on the tollgate information or the value information and the information for identifying the vehicle (step S130). The accounting processing device transmits the generated usage fee information 290 to various servers 30 (the ETC server 30-1 or the electronic money server 30-2) (step S140).

Subsequently, the communicator 31 receives the usage fee information 290 (the usage fee information 290-1 or 290-2) from the accounting processing device 20 (the accounting processing device 20-1 or 20-2) installed at each tollgate (step S150). The charging processor 32A performs a charging process on the vehicle based on the usage fee information 290 (step S160). The charging information extractor 32B extracts the charging information 300A for each payment proxy service provider (step S170). The communicator 31 transmits the extracted charging information for each payment proxy service provider to the payment proxy processing device 40 owned by each payment proxy service provider (step S180).

Subsequently, the communicator 41 receives the charging information from the various servers 30 (step S190).

The payment processor 43 pays the ETC service provider or the electronic money service provider a total amount of usage fee indicated by the charging information by proxy based on the charging information (step S200). The payment information extractor 44 extracts the payment information (the payment information 400A or 400B) stored in the payment proxy service database 400 for each registrant of the ETC system or each registrant of the electronic money service (that is, each vehicle service provider) (step S210). The communicator 41 transmits the extracted payment information of each vehicle service provider to the vehicle payment support device 50 owned by each vehicle service provider (step S220).

Subsequently, the communicator 51 receives the payment information from the payment proxy processing device 40 (step S230). The charged fee calculator 53 calculates a charged fee to be charged to the user of the vehicle for which the usage fee indicated by the payment information is charged based on the payment information (step S240).

### [Conclusion of Embodiment]

As described above, the vehicle payment system 1 according to the embodiment includes the accounting processing devices 20 (the accounting processing devices 20-1 and 20-2), the various servers 30 (the ETC server 30-1 and the electronic money server 30-2), the payment proxy processing device 40, and the vehicle payment support device 50. The acquirer 21A of the accounting processing device 20 acquires the identification information (the ETC card ID or the contactless IC chip ID) of the vehicle (the rental car RC in the example of the embodiment).

The fee information generator 21B calculates a usage fee (a usage fee of a toll road or a usage fee in electronic money) used by the vehicle and generates the usage fee information 290 based on the identification information. The charging processor 32A of the various servers 30 charges a target with the identification information (the rental car RC or the communication terminal 60) and generates the charging information 300A based on the usage fee information 290. The payment processor 43 of the payment proxy processing device 40 performs a payment proxy process for the usage fee and generates the payment information (the payment information 400A and the payment information 400B) based on the identification information and the usage fee indicated by the charging information 300A. The charged fee calculator 53 of the vehicle payment support device 50 calculates a charged fee to be charged to the user of the rental car RC based on the identification information and the usage fee indicated by the payment information.

In the vehicle payment system 1 according to the embodiment, even when the user of the rental car RC does not have the ETC card 11, the usage fee can be paid simply along with a usage fee of the rental car RC using the automated collection service of the usage fee of the toll road incurred using the ETC system. In the vehicle payment system 1 according to the embodiment, even when the user of the rental car RC does not have the communication terminal 60 on which the contactless IC chip is mounted, the usage fee can be paid simply along with the usage fee of the rental car RC using the automated collection service of an electronic money fee incurred using the electronic money system.

The vehicle payment support device 50 of the vehicle payment system 1 according to the embodiment can calculate a usage fee for each user based on the usage information 500A even when the rental car RC used by the user is the same. Thus, the vehicle payment system 1 according to the embodiment can charge each user a usage fee of the user.

[Identification Information Other than ETC Card ID]

As described above, the case in which the ETC card ID is included in the registration information 300B-1 and the registration information 400C, but the present invention is not limited thereto. When identification information of a charging target person (in this example, a vehicle service provider) is used between the ETC service provider and the payment proxy service provider, the identification information may be used in the registration information 300B-1 instead of the ETC card ID. When identification information of a payment proxy target person (in this example, a vehicle service provider) is used between the payment proxy service provider and the vehicle service provider, the identification information may be used in the registration information 300B-1 instead of the ETC card ID.

### [Insertion and Removal of ETC Card or Exchange of Communication Terminal]

As described above, the ETC card ID or the contactless IC chip ID, and the rental car ID are associated in the use information 500A, but the present invention is not limited thereto. Here, for example, when the number of rental cars RC owned by the vehicle service provider does not match the number of ETC cards 11, the ETC cards 11 mounted on the rental cars RC are changed. A combination between the rental cars RC and the communication terminals 60 are changed in order in some cases. In these cases, the vehicle service provider may have information in which the ETC cards 11 or the communication terminals 60, and the rental cars RC are associated. For example, the charged fee calculator 53 calculates an amount of charged money to be charged to the user based on the payment information 400A, the information, and the usage information 500A.

In this case, in the usage information 500A, the ETC card ID may not be associated.

### [When Usage Fee of a Toll Road is Discounted]

As described above, the various servers 30 requests the payment proxy service provider to pay a usage fee of a toll road or a usage fee in electronic money calculated by the accounting processing device 20 by proxy, but the present invention is not limited thereto. For example, when the ETC service provider or the electronic money service provider discounts the usage fee of the toll road or discounts the usage fee in electronic money, the various servers 30 may request the payment proxy service provider to pay a fee different from the fee calculated by the accounting processing device 20 by proxy.

### [When FOB Key Can Use Electronic Money Service]

As described above, the user of the rental car RC uses the electronic money system using the contactless IC chip mounted on the communication terminal 60, but the present invention is not limited thereto. For example, when the contactless IC chip ID is mounted on a key used for a passive entry system of the rental car RC (for example, a frequency operated button key: hereinafter referred to as an FOB key), the user of the rental car RC may use the electronic money system using the FOB key.

### [Identification Information of Electronic Money Service]

As described above, the information for identifying the communication terminal 60 using electronic money is the contactless IC chip ID, but the present invention is not limited thereto. The information for identifying the communication terminal 60 may be, for example, a subscriber identity module (SIM) ID mounted on the communication terminal 60 instead of the contactless IC chip ID. The information may be a serial No. of the communication terminal 60.

### [Payment of Other Usage Fee]

As described above, a usage fee of a toll road paid with the ETC card and the usage fee paid by the contactless IC chip of the communication terminal 60 using the electronic money system are charged to the user by the vehicle service provider in conjunction with the usage fee of the rental car RC, but the present invention is not limited thereto. Another fee other than the usage fee of the toll road or the usage fee incurred using the electronic money system may be associated with the usage fee of the rental car RC. The other fee may be, for example, a purchase fee incurred at the time of purchase of an application used on the communication terminal 60, a usage fee incurred for use of the application, a purchase fee of a product incurred in Internet shopping using the communication terminal 60, or the like. The fee may be paid using a credit card that is a credit card registered in advance in the communication terminal 60 and is a credit card registered in the name of the vehicle service provider or may be paid to a communication provider providing a communication service by the communication terminal 60 in conjunction with a communication fee of the communication terminal 60. A communication fee incurred in calling or communication by the communication terminal 60 may be charged to the user by the vehicle service provider in conjunction with the usage fee of the rental car RC.

### [Payment for Each Compartment or Each Seat]

As described above, the user of the rental car RC is one person and is specified uniquely, but the present invention is not limited thereto. For example, when the rental car RC is used for ridesharing, the usage fee of the rental car RC is divided by the user using the rental car RC and the divided usage fee may be charged to the user. In this case, the rental car RC has a configuration in which a user can be identified for each compartment or each seat. For example, in the rental car RC, the detection device 22 is provided for each compartment or each seat and the user holds up the communication terminal 60 to the detection device 22 of the compartment used by the own user or the detection device 22 of the seat used by the own user. Thus, the user is identified for each compartment or each seat, and the usage fee of the rental car RC of the user can correspond to the usage fee incurred using the communication terminal 60 by the user.

### [Charged Amount of Money of Vehicle Service Provider]

As described above, a simple sum of the usage fee of the toll road paid using the ETC card, the usage fee paid using the electronic money system by the contactless IC chip of the communication terminal 60, and the usage fee of the rental car RC is charged to the user by the vehicle service provider, but the present invention is not limited thereto. For example, discount or the like may be applied to the usage fee of the toll road, the usage fee incurred using the electronic money system, or the usage fee of the rental car RC may be applied by the ETC service provider, the electronic money service provider, or the vehicle service provider. In this case, the amount of money charged to the user by the vehicle service provider is an amount of money based on the applied discount.

### [When Usage Fee Information is Accumulated]

As described above, the accounting processing devices 20-1 and 20-2 transmit the usage fee information 290-1 and the usage fee information 290-2 to the server via the network NW, but the present invention is not limited thereto. Here, it is difficult to connect the accounting processing devices 20-1 and 20-2 installed in mountainous areas to the network NW through wireless communication via a mobile communication network such as Long Term Evolution (LTE) and transmit the usage fee information 290-1 and the usage fee information 290-2 to a server depending on a radio wave reception state in some cases. In this case, the ETC in-vehicle device 10 or the communication terminal 60 may accumulate the usage fee information 290-1 and the usage fee information 290-2. For example, when the communication terminal 60 can be connected to the network NW through a communication service provided by a communication provider, the usage fee information 290-1 and the usage fee information 290-2 accumulated in the ETC in-vehicle device 10 or the communication terminal 60 are transmitted to the server. In this case, the ETC in-vehicle device 10 may operate to receive communication in a half-operation such as a sleep mode, a low power consumption state, or the like to accumulate the usage fee information 290-1.

When the rental car RC has a configuration accessible to the network NW and access to the network NW through a communication service provided by the communication provider is possible, the usage fee information 290-1 and the usage fee information 290-2 accumulated in the ETC in-vehicle device 10 or the communication terminal 60 may be transmitted to a server. In this case, when the rental car RC normally validates only a low-output communication function using short-range wireless communication, a low power wide area (LPWA), or the like and moves to a place at which access to the network NW via a communication service provided by the communication provider is possible or the user gets into the rental car RC, the usage fee information 290-1 and the usage fee information 290-2 accumulated in the ETC in-vehicle device 10 or the communication terminal 60 may be transmitted to the server.

### [Association of Payment of Terminal Device of User]

As described above, when the user of the rental car RC rents the rental car RC from a vehicle service provider, the user rents the communication terminal 60 capable of using electronic money together, and the usage fee incurred using the electronic money system is associated with the usage fee of the rental car RC, but the present invention is not limited thereto. The vehicle payment system 1 may be able to associate various fees used in a terminal device owned by the own user of the rental car RC (hereinafter referred to as a terminal device TM) with the usage fee of the rental car RC used by the user. In this case, the vehicle payment system 1 associates the usage fee information 290 of the various fees used in the terminal device TM with the usage fee of the rental car RC, for example, by allowing the user to input a coupon code which is a coupon code distributed to the user of the rental car RC and a coupon code capable of identifying the user into the terminal device TM.

In this case, the vehicle payment support device 50 (the vehicle service provider) may provide a service for discounting various usage fees paid in the terminal device TM identified with the coupon code while the user uses the rental car RC. When the terminal device TM identified with the coupon code performs payment in the electronic money system, a usage fee required for the payment may be charged on a later date in conjunction with the usage fee of the rental car RC. The coupon code is exemplary and the terminal device TM may be identified in accordance with another method.

### [When Charged Fee is Charged for Each Predetermined Period]

As described above, the charge amount of money in which the usage fee of the toll road paid with the ETC card, the usage fee paid using the electronic money system by the contactless IC chip of the communication terminal 60, and the usage fee of the rental car RC are combined is calculated when the user uses the rental car RC, but the present invention is not limited thereto. For example, the charged fee may be calculated for each predetermined period. The predetermined period is, for example, a period of about 1 month. In this case, in the vehicle payment system 1, the charging information extractors 32B-1 and 32B-2 may extract a usage fee of a toll road for each predetermined period or extract a usage fee incurred using the electronic money system, the payment information extractor 44 may extract payment information of each vehicle service provider for each predetermined period, or the charged fee calculator 53 may calculate a charged fee for each predetermined period. Thus, when the user uses the rental car RC a plurality of times within the predetermined period, the vehicle payment system 1 can reduce labor for calculating a charged fee and the user can also reduce labor for paying a charged fee.

The charged fee calculator 53 may perform only a process of associating payment information extracted by the payment information extractor 44 for each user of the rental car RC until the predetermined period passes and may perform a process of calculating a charged fee of a user based on the payment information associated with the user until the predetermined passes after the predetermined period passes. Thus, it is possible to reduce the number of times the charged fee calculator 53 calculates the charged fee and reduce a process load of the vehicle payment support device 50.

### [When User Pays Basic Fee]

As described above, the charged fee calculator 53 calculates the charged fee based on usage results of the usage fee of the toll road used by the user, the usage fee incurred using the electronic money system, and the usage fee of the rental car RC, but the present invention is not limited thereto. For example, the vehicle payment system 1 may administrate the usage fee of the toll road used by the user, the usage fee incurred using the electronic money system, and the usage fee of the rental car RC in accordance with the usage fee paid by the user to the vehicle service provider. In the following description, a service in which the user pays a predetermined usage fee (hereinafter referred to as a basic fee) and the usage fee of the toll road used by the user, the usage fee incurred using the electronic money system, and the usage fee of the rental car RC are administrated is referred to as a “basic fee administration service.” The user may pay the basic fee, for example, before the “basic fee administration service” is used or may pay the basic fee after the “basic fee administration service” is used.

In the “basic fee administration service,” for example, the vehicle service provider collects the basic fees from users and pays some or all of the collected basic fees among the collected basic fees to the payment proxy service provider, the ETC service provider, or the electronic money service provider. Hereinafter, a case in which the vehicle service provider pays a dividend in which some or all of the basic fees collected from the users are divided to the ETC service provider and the electronic money service provider (that is, excluding the payment service provider) will be described.

The ETC service provider and the electronic money service provider are a user of the “basic fee administration service” and a usage fee of a user of each service is administrated in accordance with a dividend of the basic fee paid by the vehicle service provider. In this case, each business provider may administrate a dividend of each user related to the “basic fee administration service” for each user or may administrate a usage fee of a user of each service by adding the dividends related to the “basic fee administration service.” Hereinafter, a case in which the ETC service provider and the electronic money service provider administrate the dividend of each user related to the “basic fee administration service” for each user will be described.

In this case, each database of the ETC service provider and the electronic money service provider stores “dividend information” in which a user ID of a user using the “basic fee administration service” and information indicating the dividend of the user with the user ID are associated. The ETC server 30-1 and the electronic money server 30-2 include a functional unit (subtraction processing unit) that performs a process of subtracting the usage fees of various services used by the users from the dividend information. For example, the subtraction processing unit specifies users who are users associated with the user IDs of the users using the “basic fee administration service” with reference to the usage information 500A or the usage information 500B via the network NW and are users using the various services. The subtraction processing unit subtracts the usage fees incurred using the various services from the dividend information with reference to the dividend information of a specific user and updates the subtracted amount of money as the dividend information.

Here, the user uses only an amount of money less than an amount of money paid as the basic fee (that is, the basic fee is greater than the used usage fee) in some cases. In these cases, the vehicle service provider may recover the surplus amount of money from the ETC service provider or the electronic money service provider and refund the surplus amount of money to the user. The user uses an amount of money equal to or greater than the amount of money paid as the basic fee (that is, the basic fee is less than the used usage fee) in some cases. In these cases, the vehicle service provider may recover the insufficient amount of money from the user or may recover the insufficient amount of money as an incentive from the ETC service provider or the electronic money service provider. Thus, the vehicle payment system 1 can reduce labor for paying the usage fee when the user uses various services.

While preferred embodiments of the invention have been described and illustrated above, it should be understood that these are exemplary of the invention and are not to be considered as limiting and can be appropriately changed within the scope of the present invention. The configurations described in each of the above-described embodiments may be combined.

What is claim is:

1. A vehicle payment support device comprising:
an acquirer configured to acquire payment information of a fee which is able to be associated with identification information of a vehicle providing a service from a fee collection system; and
an associator configured to associate the service from the vehicle and the payment information with identification information of the vehicle and associate a price of the service by the vehicle and a price of a service or a product of which payment is confirmed by the fee collection system with the identification information of the vehicle.

2. The vehicle payment support device according to claim 1,
wherein the fee collection system confirms the payment by authenticating a card medium,
wherein the payment information of the fee associable with the identification information of the vehicle includes card identification information stored in the card medium, and
wherein the associator associates the payment information with the identification information of the vehicle with reference to association information of the identification information of the vehicle and the card identification information, and associates the price of the service by the vehicle and the price of the service or the product of which the payment is confirmed by the fee collection system with the identification information of the vehicle.

3. The vehicle payment support device according to claim 1,
wherein the fee collection system confirms the payment by authenticating a key used for locking and unlocking of the vehicle,
wherein the payment information of the fee associable with the identification information of the vehicle includes key identification information stored in the key, and
wherein the associator associates the payment information with the identification information of the vehicle with reference to association information of the identification information of the vehicle and the key identification information, and associates the price of the service by the vehicle and the price of the service or the product of which the payment is confirmed by the fee collection system with the identification information of the vehicle.

4. The vehicle payment support device according to claim 1,
wherein the fee collection system confirms the payment by authenticating a communication terminal associated with the vehicle,
wherein the payment information of the fee associable with the identification information of the vehicle includes communication terminal identification information stored in the communication terminal, and
wherein the associator associates the payment information with the identification information of the vehicle with reference to association information of the identification information of the vehicle and the communication terminal identification information, and associates the price of the service by the vehicle and the price of the service or the product of which the payment is confirmed by the fee collection system with the identification information of the vehicle.

5. The vehicle payment support device according to claim 1,
wherein the fee collection system confirms the payment by authenticating a communication terminal associated for each compartment or seat of the vehicle,
wherein the payment information of the fee associable with the identification information of the vehicle includes communication terminal identification information stored in the communication terminal, and
wherein the associator associates the payment information with the identification information of the vehicle with reference to association information of the identification information of the vehicle and the communication terminal identification information, and associates the price of the service by the vehicle and the price of the service or the product of which the payment is confirmed by the fee collection system with the identification information of the vehicle.

6. The vehicle payment support device according to claim 1, wherein the associator associates the payment information with the identification information of the vehicle based on a period in which a user uses the vehicle and associates the price of the service by the vehicle and the price of the service or the product of which the payment is confirmed by the fee collection system with the identification information of the vehicle.

7. A vehicle payment support device comprising:
an acquirer configured to acquire payment information of a fee;
a transmitter configured to associate a service by a vehicle with the payment information of the fee, and associate identification information of the vehicle and the payment information of the fee and transmit the identification information of the vehicle and the payment information of the fee to a fee collection system in accordance with the transmission to the fee collection system; and
an associator configured to associate the service from the vehicle and the payment information with the identification information of the vehicle when the transmitter transmits the identification information of the vehicle, and associate a price of the service by the vehicle and a price of a service or a product of which payment is confirmed by the fee collection system with the identification information of the vehicle.
